(19) United States
(12) Patent Application Publication
(10) Pub. No.: US 2007/0136564 A1
(43) Pub. Date: Jun. 14, 2007

(54) Method and apparatus to save and restore context using scan cells

(75) Inventors: Sankaran Menon, Austin, TX (US); John Fernando, Austin, TX (US); Ravi Kolagotla, Austin, TX (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 11/302,742

(22) Filed: Dec. 14, 2005

(51) Int. Cl. G06F 9/44

(52) U.S. Cl. 712/228

(57) ABSTRACT

Apparatus including a save path to connect an output of a first latch of a first save/restore cell of a save/restore chain to an input of a second latch of the first save/restore cell, a restore path to connect an output from the second latch to an input of the first latch, and a scan path to connect the output of the second latch to an input of a second save/restore cell of the save/restore chain. The apparatus is useful for fast context switching.

### BACKGROUND

Digital systems contain processors that execute programs. A program being executed is called a process. Programs can be written to contain more than one thread of execution. A thread of execution is a part of a program that can execute independently of the other parts. A processor context can be either a process or a thread. Context switching provides efficient use of processor time by allowing the processor to work on multiple tasks. For example, if a process or thread is waiting for input, a processor may set temporarily aside that context and switch to work on another.

Context switching can be time consuming. For process switching, memory maps and file descriptor tables may need to be recreated. If switching processes involves switching applications, the operating system must perform certain computations to configure the application for the particular device. This can include initializing a graphical windowing system and building various data structures. For thread switching, the state of the processor may have to be recreated. Also, the priorities of waiting threads may have to be recalculated and in some operating systems (OS) these priorities are recalculated only occasionally. The system overhead involved with context switching can be costly in terms of processor execution time. Typically, saving and restoring contexts in digital systems requires additional buses and logic dedicated for this purpose. This adds to the design cost of digital systems in terms of complexity and size. The present inventors have recognized a need for improved context switching in digital systems.

### BRIEF DESCRIPTION OF THE DRAWINGS

FIG. 1 is a block diagram of a portion of an embodiment of a save/restore chain for use in digital system.

FIG. 2 shows an embodiment of a save/restore cell.

FIG. 3 shows a timing diagram illustrating operation of a save/restore cell.

FIG. 4 is a block diagram of a portion of an embodiment of a system that includes a save/restore chain.

FIG. 5 shows a timing diagram illustrating operation of a save/restore cell.

FIG. 6 is a block diagram of portions of an embodiment of a system that includes a save/restore chain.

FIG. 7 is a block diagram of a method of processor context switching.

### DETAILED DESCRIPTION

In the following detailed description, reference is made to the accompanying drawings which form a part hereof, and in which is shown by way of illustration specific embodiments in which the invention may be practiced. It is to be understood that other embodiments may be used and structural and logical changes may be made without departing from the scope of the present invention.

This document describes systems and methods to provide context switching in digital systems. Digital systems include any system using at least one processor such as a personal computer, a personal data assistant (PDA), or a mobile telephone for example. Digital systems also include larger, multiprocessor systems. Typically, saving and restoring contexts in digital systems requires additional buses and dedicated logic which adds to the complexity and size of the systems.

Scan cells are storage circuit elements such as latches and flip-flops which are connected to functional cells to form a serial chain. A scan chain runs from a functional cell to a scan cell to the next functional cell to the next scan cell and so on. Scan cells are typically only used in digital systems for system hardware validation. In hardware validation, test patterns are run through a system using functional clocks. The functional clocks are then frozen and the data from functional cells are read out serially by clocking the scan chain with scan clocks. The test patterns are used to detect whether functional cells or other logic circuits have stuck-at-faults. Because a scan chain often exists as part of a digital system design, redesigning the functionality of a scan chain into a save/restore chain adds context switching to a digital system without also adding a large amount of additional circuitry.

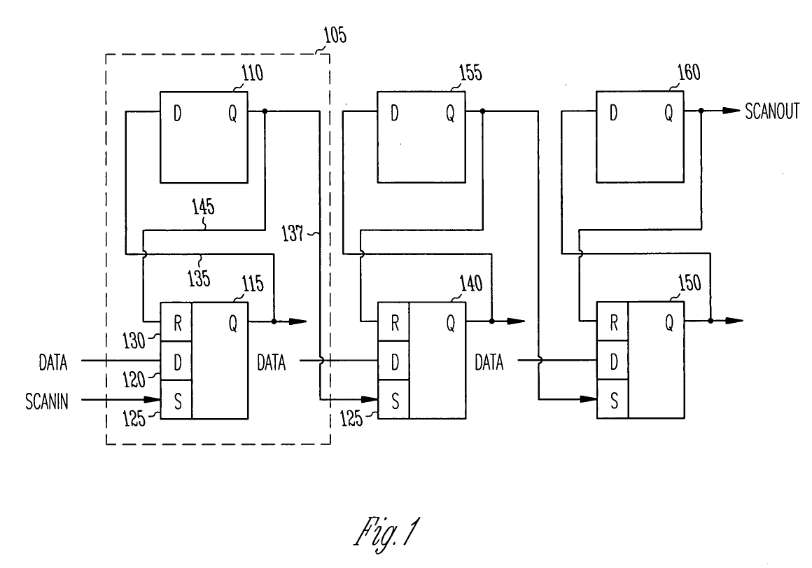

FIG. 1 is a block diagram of a portion of an embodiment of a save/restore chain 100 for use in digital system. The save/restore chain 100 is used to save and restore a processor context in a digital system. The save/restore chain includes save/restore cells 105. A save/restore cell 105 includes a first functional latch 115 and a second latch 110. The functional latch 115 includes an output and three inputs: a data input 120, a scan input 125, and a restore input 130. The save/restore cell 105 includes a save path 135, a restore path 145, and a scan path 137. The save path 135 connects the output of the functional latch 115 to the input of the second latch 110 and is used to store data from the functional latch 115. The restore path 145 connects the output of the second latch 110 to the restore input 130. The scan path 137 connects the output of the second latch 110 to the scan input 125 of a subsequent save/restore cell in the save/restore chain 100.

To simplify the block diagram, the clock connections are not shown. Data is stored into the functional latch 115 synchronously with clock pulses. The save path 135 and the scan path 137 can be used to implement scan functionality. In some embodiments, scan data is stored into the functional latches 115, 140, 150 on a first scan clock signal and scan data is stored into the second latches 110, 155, 160 on a second scan clock signal. In some embodiments, scan data is clocked into the functional latches 115, 140, 150 and the second latches 110, 155, 160 using the same scan clock signal. This is possible if the latches are edge triggered and there are no race conditions in the design and lay out of the digital system.

The save path 135 and the restore path 145 are used to implement save/restore functionality. The save/restore functionality allows a context of the system as manifested by the data in the functional latches 115, 140, 150 to be stored in the second latches 110, 155, 160 of the save/restore cells. This stored context data can be restored o the system at a later time. Normal system operation clocks data from the data input 120 into the functional latch using a system clock. To save the context data, the system clock is stopped and data is saved in the second latches 110, 155, 160 using a save clock. Normal system operation then resumes by restarting the system clock. To restore the context data, the system clock is again stopped and the saved context data is restored to the functional latches 115, 140, 150 from the second latches 110, 155, 160 using a restore clock.

For brevity, only three save/restore cells 105 are shown in FIG. 1. Because a save/restore chain 100 saves and restores a processor context, the save/restore chain 100 contains a sufficient number of save/restore cells 105 to store a processor context. This can include providing a save/restore cell 105 corresponding to every functional latch in the design of the processor, but this is not necessary. Save/restore chains can have less than a save/restore cell 105 for each functional latch in a design. Some embodiments of a save/restore chain include a mixture of save/restore cells and simple scan cells in positions along the chain where restoring the data is not required. In some embodiments, not every functional latch is connected to the scan string. A functional latch not connected to a scan chain does not need to be connected to a scan cell.

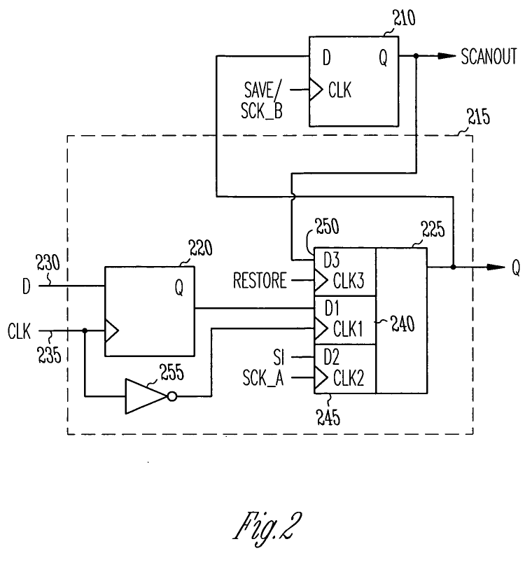

FIG. 2 shows an embodiment of a save/restore cell 200. The save/restore cell 200 includes a save/scan latch 210 and a functional latch 215. The functional latch 225 includes a first latch 220 and a second latch 225. The first latch 220 includes the data input 230 and the clock input 235 for the functional latch 215.

The second latch 225 includes three inputs: a data input 240 connected to the output of the first latch 220, the scan input 245 for the functional latch 215, and the restore input 250 for the functional latch 215. The output of the second latch 225 is the output for the functional latch 225. In some embodiments, the functional latch circuit 215 includes a clock logic circuit coupled to the clock input 235 and the data clock of the second latch. The clock logic circuit causes data to be clocked into the first latch 220 on a first edge of a clock pulse and into the second latch on the second edge of the clock pulse. In an illustrative example, data is clocked into the first latch 220 on a rising edge of a clock pulse and into the second latch 225 on a falling edge of the clock pulse. In FIG. 2, the clock logic circuit is inverter 255. In some embodiments, the clock logic circuit includes buffers to balance loading on a clock signal.

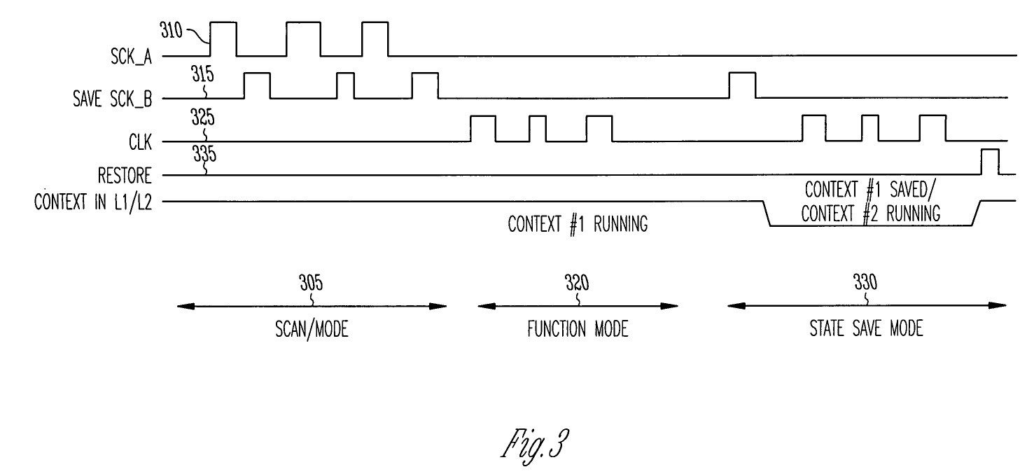

FIG. 3 shows a timing diagram 300 that illustrates operation of the save/restore cell 200 in FIG. 2. In scan mode 305, a first scan clock 310 (Sck_a) clocks scan data (SI) into the functional latch 215 from a save/scan latch of a previous save/restore cell in the save/restore chain. A second scan clock 315 (Save/Sck_b) clocks scan data into the save/scan latch 210. Data is advanced through save/restore cells 200 along the save/restore chain by alternate clocking of the scan clocks 310, 315. In functional mode 320, data is clocked into the functional latch 215 using the clock input 325 (Clk). FIG. 3 shows Clk 325 running to execute a first context—Context #1. To save the context, in state save mode 330, Clk 325 is halted and data at the functional latch output is saved into the save/scan latch 210 by the single clock pulse of Save/Sck_b 315. After Context #1 is saved, Context #2 begins executing and data is clocked into the functional latches using Clk 325. The saved state of Context #1 remains in the save/scan latches. To restore Context #1 after Context #2 is halted, Clk 325 is halted and Context #1 data is restored to the functional latch by Restore clock 335. Context #1 then continues executing from its last saved state.

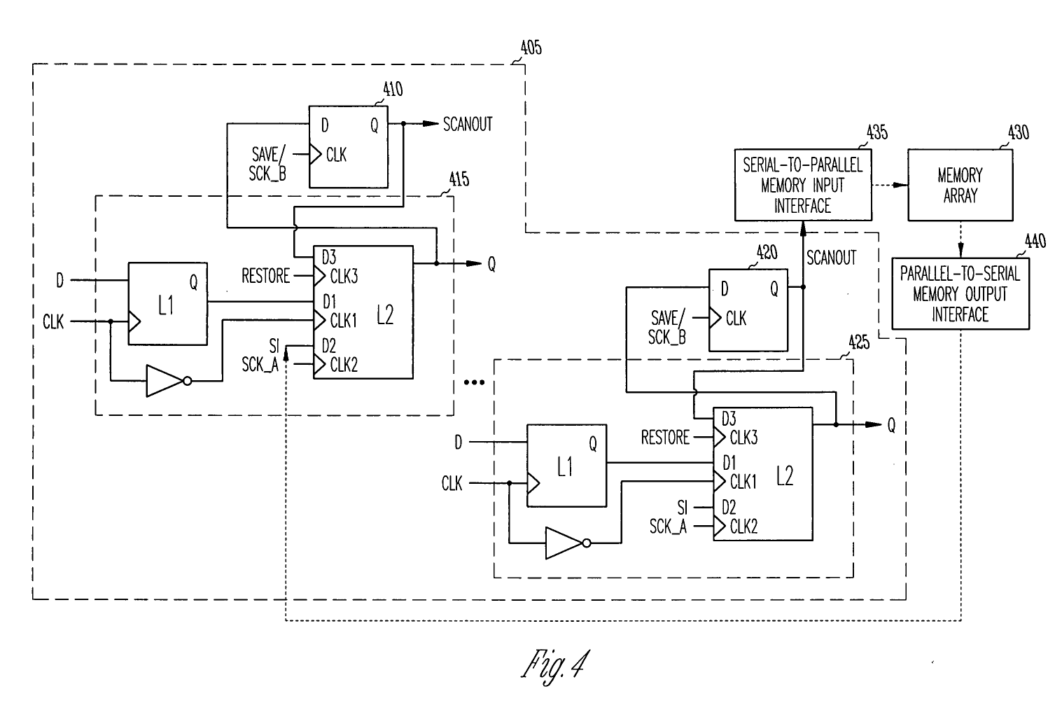

FIG. 4 is a block diagram of a portion of an embodiment of a system 400 that includes a save/restore chain 405. Two save/restore cells are shown. The first save/restore cell includes save/scan latch 410 and functional latch 415 and is the first cell in the save/restore chain 405. The second save/restore cell shown includes save/scan latch 420 and functional latch 425 and is the last cell in the save/restore chain 405. The save/restore chain 405 includes a sufficient number of save/restore cells to save and restore a processor context. A memory array 430 is connected to the save/scan latch 420 of the last save/restore cell in the chain 405 through a serial-to-parallel memory interface 435. In some embodiments, the memory array 430 includes a random access memory (RAM). In some embodiments, the memory array 430 includes a static random access memory (SRAM). In some embodiments, the memory array 430 includes flash memory.

The memory array 430 has sufficient size to store at least one save/restore chain 405, i.e., the memory array 430 includes at least one memory cell for every save/scan latch and for every functional latch in the chain 405. Thus, the memory array 430 has sufficient size to store at least one context. The context data is loaded from the save/restore chain 405 into the memory array 430. To load the context data into the memory array 430, serial-to-parallel memory input interface 435 receives the data from the save/restore chain 400 serially loads the data into a register. The contents of the register are then stored in the memory array 430.

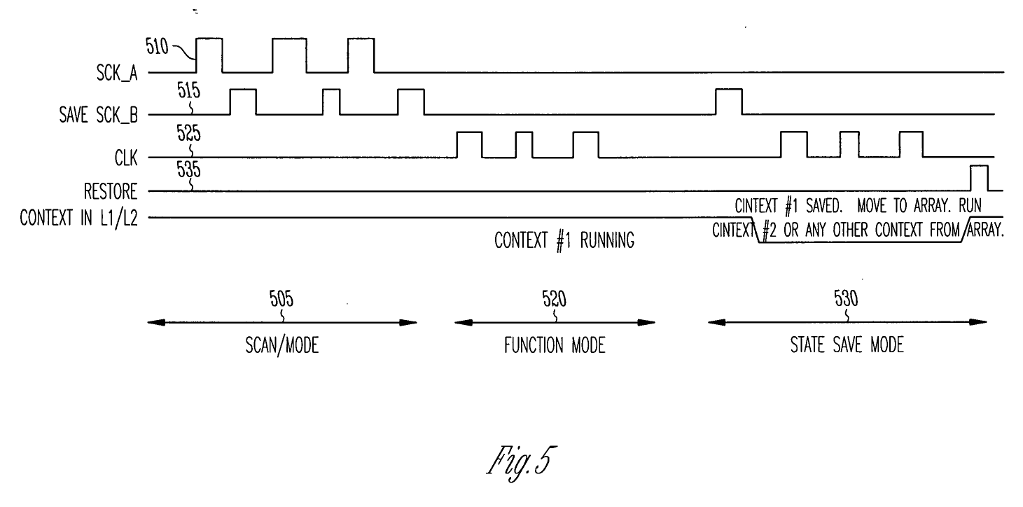

FIG. 5 shows a timing diagram 500 that illustrates operation of the save/restore cell 405 in FIG. 4. In scan mode 505, a first scan clock 510 (Sck_a) clocks scan data into the functional latches 415, 425 of the save/restore chain 405 through the scan data input (SI). A second scan clock 515 (Save/Sck_b) clocks scan data into the save/scan latches 410, 420 of the scan/restore chain 405. Data is advanced along the save/restore chain 405 by alternate clocking of scan clocks 510, 515. In functional mode 520, data is clocked into the functional latch using the clock input 525 (Clk). FIG. 5 shows Clk running in a first context, Context #1, in functional mode 520. To save the context, in state save mode 530, Clk 525 is halted and data at the functional latch output is saved into the save/scan latch by the single clock pulse of Save/Sck_b 515. After Context #1 is saved, Context #2 begins executing and data is clocked into the functional latch using Clk 525. The saved state of Context #1 can either remain in the save/scan latches or can be shifted into the memory array 430 before executing Context #2.

If Context #1 remains in the save/scan latches, to restore Context #1 after Context #2 is halted, Clk 525 is halted and Context #1 data is restored into the functional latches by Restore clock 535. Context #1 then continues executing from its last saved state. If Context #1 is stored in the memory array 430, to restore Context #1 after Context #2 is halted, Clk 525 is halted and Context #1 is loaded into the save/restore chain 405 from the memory array 430. To load data into the save/restore chain 405, context data is loaded into registers in the parallel-to-serial memory output interface 440. Data is then shifted serially from the registers into the save/restore chain 405 and shifted along the save/restore chain 405 using alternating scan clocks 510, 515. When Context #1 is loaded into the save/restore chain 405, it is then transferred to the functional latches using Restore clock 535.

If the memory array 430 has sufficient size to store at least one context, then at least two stored contexts can be nested in the system 400. Nesting refers to saving and restoring the contexts in a last-in first-out manner. As an illustrative example, assume a first context of a program is executing on a processor in the system 400 and assume the memory array 430 is empty. The program receives a prompt to run a second context. The prompt can be an asynchronous event such as an input to the system from a user or an input from a second processor, for example. The first context is stored in the save/restore chain 405. During execution of the second context, the program receives a prompt to run a third context. The first context is shifted into the memory array 430 using the scan clocks 510, 515 (Sck_a, Save/Sck_b). The second context is stored in the save/restore chain 405 using the save clock 515 (Save/Sck_b). The first and second contexts are nested in that the second context must be executed next after the third context completes because there is only room for one context in the memory array 430 and the first and second context cannot be swapped. After the second context completes, the first context can be loaded into the save/restore chain 405 using alternating scan clocks 510, 515, and restored to the functional latches using Restore clock 535.

If the memory array 430 is of sufficient size to store at least two contexts, then context swapping can be performed using the memory array 430. To see this, assume as in the previous example that a third context is running and that a first context is stored in the memory array 430 and a second context is stored in the save/restore chain 405. After the third context completes, the processor can execute either the first context or the second context. To run the first context, the second context is loaded into the memory array 430 and the first contest is loaded from the memory array 430 into the save/restore chain 405 and restored. Alternatively, both contexts could be stored into the memory array 430 while the third context is executing. Either the first or second context is loaded from the memory array 430 into the save/restore chain 405 and restored into the functional latches.

If the memory array 430 is of sufficient size to store the three contexts, then any context that is executing can be interrupted, loaded into the save/restore chain 405, and stored in the memory array 430. Any context stored in the memory array 430 can then be loaded into the save/restore chain 405, restored to the functional latches, and executed. These concepts can of course be extended beyond the example of three contexts running on a digital system. For example, if there are N contexts to be run on a digital system where N is an integer, then if the memory array 430 is of sufficient size to store N contexts, then any context that is executing can be interrupted, loaded into the save/restore chain 405, and stored in the memory array 430. And any context stored in the memory array 430 can then be loaded into the save/restore chain 405, restored to the functional latches, and executed.

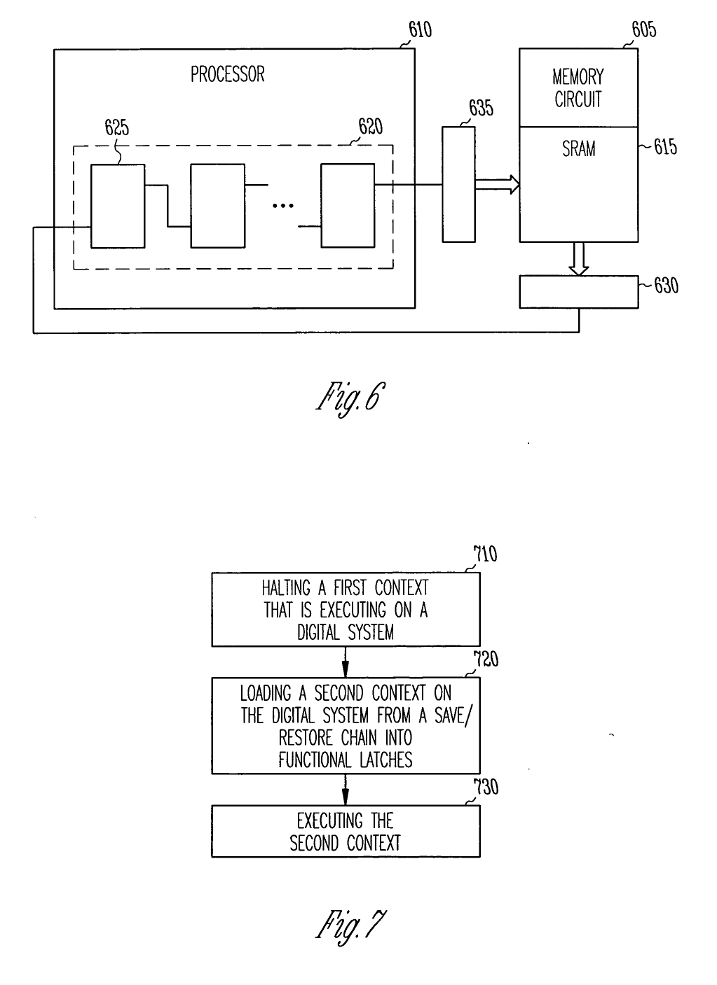

FIG. 6 is a block diagram of portions of an embodiment of a system 600. The system includes a memory circuit 605 and a microprocessor 610. The memory circuit 605 includes a static random access memory (SRAM) array 615. The microprocessor 610 includes a plurality of save/restore cells 625 connected to form a save/restore chain 620. The save/restore chain 620 includes a number of save/restore cells 625 sufficient to store a context of the microprocessor 610. The save/restore cells 625 include a save path to connect an output from a first functional latch to a save/scan latch of a first cell, a scan path to connect an output of the save/scan latch to an input of a second functional latch of a second cell, and a restore path to connect an output from the save/scan latch of the first cell to an input of the first functional latch of the first cell.

In some embodiments, the system 600 further includes interface logic 630 coupled to the memory circuit 605 and the save/restore chain 620 to load the microprocessor context data from the memory array 615 into the save/restore chain 620. The system 600 also includes interface logic 635 to store microprocessor context data into the memory array 615 from the save/restore chain 620. In some embodiments, the system 600 is included in a digital system such as a personal computer, a personal data assistant (PDA), or a mobile telephone.

FIG. 7 is a block diagram of a method 700 of processor context switching in a digital system. At 710, a first context that is executing on the digital system is halted. At 720, a second context is loaded on the digital system from a save/restore chain into functional latches. At 730, the second context is executed. In some embodiments, the method 700 further includes interrupting execution of the second context, storing the second context in the save/restore chain, and executing a third context on the digital system.

Interrupting the second context and storing the second context may occur in response to an asynchronous event causing the third context to begin executing. An example of an asynchronous event includes an input from a second processor, such as when the first processor delays executing the third context until it receives an input signal from the second processor. Another example includes an input from a user that requests the third context. In some embodiments, the method 700 further includes recurrently interrupting execution of the second context and storing the second context in the save/restore chain, executing other contexts on the digital system, and recurrently loading and executing the second context after execution of the other contexts. This is useful when other contexts having a higher priority than the second context are to be executed on the digital system.

According to some embodiments of the method 700, loading the second context on the digital system includes loading the second context from a memory array into the save/restore chain before it is loaded into the functional latches. In some embodiments, loading the second context includes shifting context data along the save/restore chain using one scan clock, such as when the latches used in the save/restore chain are edge triggered and there are no race conditions. In some embodiments, the shifting is done using two non-overlapping scan clocks, one to clock context data into functional latches and one to clock context data into save/scan latches. In some embodiments, the shifting through the save/restore chain results in the context data loaded into the functional latches. In some embodiments, a restore clock is used to load the context data from the save/scan latches of the save/restore string into the functional latches.

According to some embodiments, the method 700 further includes swapping contexts stored in a memory for execution on a processor of a system. For the simple case of swapping a first and second context, this involves interrupting a first context executing on the system, transferring the first context from functional latches of the system into a save/restore chain, transferring the first context from the save/restore chain into a memory array for storage, and loading the second context from the memory array into the save/restore chain before executing the second context.

The contexts can also be swapped the other way. This includes interrupting the second context, transferring the second context from functional latches into a save/restore chain, transferring the second context from the save/restore chain into a memory array for storage, loading the first context from the memory array into the save/restore chain, and loading the first context from the save/restore chain into functional latches before executing the first context.

The swapping is extendible to cases involving more than two contexts. In some embodiments, the memory array holds a plurality of contexts such as N contexts, where N is a positive integer. After interrupting either the first and second contexts and storing the interrupted context in the array, any other context can be loaded through the save/restore chain for execution. In some embodiments, the plurality of contexts corresponds to a plurality of threads to be run on the system. In some embodiments, the plurality of contexts corresponds to a plurality of processes to be run on the system. In some embodiments, the processes correspond to applications to be run on the system. In some embodiments, the applications are selectable by a user of the system. In some embodiments, the plurality of contexts includes a combination of processes and threads.

In some embodiments, the contexts are created while the system is running and a state of the context is stored that is created from executing the context. In some embodiments, the contexts are provided on a computer readable medium, such as a CD-ROM, or a diskette, or a USB memory key, or the like, and are stored in the memory array before the thread or process corresponding to the context is run on the system. In some embodiments, the contexts are downloadable onto the digital system from a network, such as a computer network or a mobile telephone network. These contexts are created by a master development system by a manufacturer. The contexts are preloaded into the memory array when the system is powered up. This is useful to quickly provide graphics content upon power-up or an application change without having to wait for the system or an application on the system to boot up.

The systems and methods described herein show how processor contexts can be saved and restored in a digital system without adding buses and logic which increase system complexity and size. The systems and methods take advantage of scan logic often used to validate system hardware by modifying scan cells and the scan chain into a save/restore chain which is used for the additional purpose of context switching.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually, collectively, or both by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own.

What is claimed is:

1. Apparatus comprising:
a save path to connect an output of a first latch of a first save/restore cell of a save/restore chain to an input of a second latch of the first save/restore cell;
a restore path to connect an output from the second latch to an input of the first latch; and
a scan path to connect the output of the second latch to an input of a second save/restore cell of the save/restore chain.

2. The apparatus of claim 1, wherein the save/restore chain includes a plurality of serially connected save/restore cells, wherein the save/restore chain has a sufficient number of the save/restore cells to store a processor context.

3. The apparatus of claim 2 further including:
a memory array having sufficient size to store at least one processor context; and
interface logic coupled to the memory array and save/restore chain to load processor context data from the memory array into the save/restore chain and from the save/restore chain into the memory array.

4. The apparatus of claim 3, wherein the memory array includes a random access memory (RAM).

5. The apparatus of claim 1, wherein the second latch includes a second input to connect a scan path from a previous save/restore cell in the save/restore chain, wherein the save/restore cell further includes a third latch having an input and an output, the output of the third latch connected to a third input of the first latch, and wherein the input of the third latch receives functional data.

6. The apparatus of claim 5,
wherein the second latch further includes a save/scan clock input to receive a save/scan clock signal to clock save data into the second latch,
wherein the third latch further includes a first data clock input; and
wherein the first latch further includes a second data clock input to clock functional data into the first latch, a scan clock input to receive a scan clock signal to clock scan data into the first latch, and a restore clock input to receive a restore clock signal to clock restore data into the first latch.

7. The apparatus of claim 6 further including a clock logic circuit coupled to the first and second data clock inputs to cause data to be clocked into the third latch upon a first edge of a single pulse of the clock signal and into the first latch upon a second edge of the single pulse of the clock signal.

8. A system comprising,
a memory circuit, the memory circuit including a static random access memory (SRAM) array; and
a processor including:
a plurality of save/restore cells connected to form a save/restore chain, the save/restore chain having a number of save/restore cells sufficient to store a processor context, wherein a first save/restore cell includes:
a save path to connect an output of a first latch to an input of a second latch;
a restore path, to connect an output from the second latch to an input of the first latch; and
a scan path to connect the output of the second latch to an input of a second save/restore cell of the save/restore chain.

9. The system of claim 8 further including interface logic coupled to the memory circuit and save/restore chain to load processor context data from the memory array into the save/restore chain and to store processor context data into the memory array from the save/restore chain.

10. The system of claim 8, wherein the system is included in a personal computer.

11. The system of claim 8, wherein the system is included in a mobile telephone.

12. The system of claim 8, wherein the system is included in a personal data assistant (PDA).

13. A method comprising:
halting a first processor context that is executing in a digital system;
loading a second processor context in the digital system from a save/restore chain into functional latches; and
executing the second processor context in the digital system.

14. The method of claim 13 further including:
interrupting execution of the second context;
storing the second context in the save/restore chain; and
executing a third context on the digital system.

15. The method of claim 14, wherein storing the second context includes storing the second context in the save/restore chain in response to an input from outside the processor that requests the third context.

16. The method of claim 15 further including:
recurrently interrupting execution of the second context and storing the second context in the save/restore chain;
executing other contexts on the digital system; and
recurrently loading and executing the second context after execution of the other contexts.

17. The method of claim 13, wherein loading a second context on the digital system includes loading the second context from a memory array into the save/restore chain.

18. The method of claim 17, wherein loading a second context includes shifting context data along the save/restore chain using at least one scan clock and loading context data into the functional latches using a restore clock.

19. The method of claim 17, wherein halting includes interrupting and the method further includes:
transferring the first context from functional latches into the save/restore chain when the first context is interrupted;
transferring the first context from the save/restore chain into the memory array for storage; and
loading the second context from the memory array into the save/restore chain before executing the second context.

20. The method of claim 19 further including:
interrupting the second context;
transferring the second context from the functional latches into the save/restore chain;
transferring the second context from the save/restore chain into the memory array for storage;
loading the first context from the memory array into the save/restore chain; and
loading the first context from the save/restore chain into the functional latches before executing the first context.

21. The method of claim 17, wherein loading the second context from a memory array includes loading the second context for execution into the save/restore chain of a digital system from a memory array containing a plurality of contexts for execution on the digital system corresponding to a plurality of applications selectable by a user.

22. The method of claim 21 further including providing a plurality of contexts of execution for storage in the memory array on a computer readable medium.

23. A computer readable medium with instructions therein, which when processed, result in a machine:
interrupting a first processor context that is executing in a digital system;
transferring the first context from functional latches into a save/restore chain;
transferring the first context from the save/restore chain into a memory array for storage;
loading a second processor context from the memory array into the save/restore chain;
loading the second processor context from a save/restore chain into the functional latches in the digital system; and
executing the second processor context in the digital system.
